(19) United States
(12) Patent Application Publication
(10) Pub. No.: US 2011/0138805 A1
(43) Pub. Date: Jun. 16, 2011

(54) CONJUGATE CURVE PROFILES FOR VANE ARMS, MAIN-ARMS, AND UNISON RINGS

(75) Inventors: Pierre Barthelet, Morrsitown, NJ (US); Olivier Espasa, Morrsitown, NJ (US); Julien Mailfert, Morrsitown, NJ (US); Nicolas Morand, Morristown, NJ (US); Emmanuel Severin, Morrsitown, NJ (US); Lionel Toussaint, Morrsitown, NJ (US)

(73) Assignee: Honeywell International Inc., Morristown, NJ (US)

(21) Appl. No.: 12/638,198

(22) Filed: Dec. 15, 2009

(51) Int. Cl. F02D 23/00; F03B 3/18

(52) U.S. Cl. 60/602; 415/164

(57) ABSTRACT

A turbocharger assembly comprises a variable-vane assembly. The variable-vane assembly includes a unison ring with vane arms and/or a main-arm which adjust the setting angle of vanes. Vane arm-engaging elements and main-arm-engaging elements in the unison ring engage ends of the vane arms and the main-arm, respectively. Each vane arm-engaging element comprises an inner contact surface that engages an outer contact surface of the respective vane arm. The main-arm-engaging element comprises an inner actuation surface that engages an outer actuation surface of the main-arm. The inner contact surface and the outer contact surface and/or the inner actuation surface and the outer actuation surface may comprise conjugate curve profiles, such as involute curve profiles based on the involute of a circle. Use of conjugate curve profiles may result in rolling movement between the unison ring and vane arms and/or main arm, which may reduce friction occurring during pivoting of the vanes.

### BACKGROUND OF THE INVENTION

1. Field of the Invention

The present application relates to variable-geometry turbocharger assemblies having vanes driven by a unison ring and having vane arms and/or main arms that engage the unison ring.

2. Description of Related Art

An exhaust gas-driven turbocharger is a device used in conjunction with an internal combustion engine for increasing the power output of the engine by compressing the air that is delivered to the air intake of the engine to be mixed with fuel and burned in the engine. A turbocharger comprises a compressor wheel mounted on one end of a shaft in a compressor housing and a turbine wheel mounted on the other end of the shaft in a turbine housing. Typically the turbine housing is formed separately from the compressor housing, and there is yet another center housing connected between the turbine and compressor housings for containing bearings for the shaft. The turbine housing defines a generally annular chamber that surrounds the turbine wheel and receives exhaust gas from an engine. The turbine assembly includes a nozzle that leads from the chamber into the turbine wheel. The exhaust gas flows from the chamber through the nozzle to the turbine wheel and the turbine wheel is driven by the exhaust gas. The turbine thus extracts power from the exhaust gas and drives the compressor. The compressor receives ambient air through an inlet of the compressor housing and the air is compressed by the compressor wheel and is then discharged from the housing to the engine air intake.

One of the challenges in boosting engine performance with a turbocharger is achieving a desired amount of engine power output throughout the entire operating range of the engine. It has been found that this objective is often not readily attainable with a fixed-geometry turbocharger, and hence variable-geometry turbochargers have been developed with the objective of providing a greater degree of control over the amount of boost provided by the turbocharger. One type of variable-geometry turbocharger is the variable-nozzle turbocharger (VNT), which includes a variable-vane assembly comprising an array of variable vanes in a turbine nozzle. The vanes are pivotally mounted to a nozzle ring and are connected to an actuation mechanism that enables the setting angles of the vanes to be varied. Changing the setting angles of the vanes has the effect of changing the effective flow area in the nozzle, and thus the flow of exhaust gas to the turbine wheel can be regulated by controlling the vane positions. In this manner, the power output of the turbocharger can be regulated, which allows engine power output to be controlled to a greater extent than is generally possible with a fixed-geometry turbocharger.

The variable-vane assembly can be prone to performance and reliability issues. It is, therefore, desirable that a vane pivoting mechanism be constructed, for use with a variable-nozzle turbocharger, in a manner that provides improved vane operational performance and reliability.

### SUMMARY OF VARIOUS EMBODIMENTS

The present disclosure in one aspect describes a variable-geometry turbocharger assembly comprising a turbine housing defining an inlet for exhaust gas and an outlet with a turbine wheel within the turbine housing and attached to a shaft, and a nozzle defining a nozzle passage for exhaust gas flow to the turbine wheel. A plurality of vanes are disposed within the nozzle passage, each vane mounted on a bearing pin and each vane configured to pivot about an axis defined by the respective bearing pin. A plurality of vane arms each comprise a proximal end connected to a respective one of the vanes and an opposite distal end defining an outer contact surface. A unison ring is rotatable substantially about a longitudinal axis defined by the shaft for pivoting the vanes about the respective axes, wherein the unison ring comprises a radially inner surface defining a plurality of circumferentially spaced vane arm-engaging elements each engaged with the distal end of one of the vane arms, each vane arm-engaging element comprising an inner contact surface that engages the outer contact surface of the respective vane arm. The inner contact surface of each arm-engaging element and the outer contact surface of each vane arm are configured as conjugate curve profiles.

The conjugate curve profiles may comprise involute curve profiles, such as an involute of a circle. For example, the involute curve profile of the inner contact surface of each arm-engaging element may comprise the involute of a first circle, the involute curve profile of the outer contact surface of each vane arm comprises the involute of a second circle, and the radius of the first circle may be greater than the radius of the second circle. Alternatively, the radius of the first circle may be less than the radius of the second circle.

The turbocharger assembly described above may additionally or alternatively include one or more main-arms for rotatably driving the unison ring, each main-arm comprising an outer actuation surface, and the radially inner surface of the unison ring may further define one or more main-arm-engaging elements each engaged with one of the main-arms. The main-arm-engaging element comprises an inner actuation surface that engages the outer actuation surface of the respective main-arm. The inner actuation surface of each main-arm-engaging element and the outer actuation surface of each main-arm may be configured as conjugate curve profiles. Further, the conjugate curve profiles of the inner actuation surface and the outer actuation surface may comprise involute curve profiles. The conjugate curve profiles may comprise involute curve profiles, such as involutes of one or more circles. For example, the involute curve profile of the inner actuation surface of each main-arm-engaging element may comprise the involute of a first circle, wherein the involute curve profile of the outer actuation surface of each main-arm comprises the involute of a second circle, and further wherein the radius of the first circle may be greater than the radius of the second circle. Alternatively, the radius of the first circle may be less than the radius of the second circle.

The present disclosure also describes a vane arm for use in a variable-vane assembly of a turbocharger. The vane arm comprises a first end configured for connection with a vane, and a second end defining an outer contact surface for engaging a unison ring of the variable-vane assembly, wherein the outer contact surface defines a conjugate curve profile with respect to another profile. The conjugate curve profile may comprise an involute curve profile, such as an involute of a circle.

Further embodiments comprise a main-arm for use in a variable-vane assembly of a turbocharger. The main-arm comprises a first end configured for connection with an actuation mechanism of the variable-geometry nozzle, and a second end defining an outer actuation surface for engaging a unison ring of the variable-vane assembly, wherein the outer actuation surface defines a conjugate curve profile with respect to another profile. The conjugate curve profile may comprise an involute curve profile, such as an involute of a circle.

A unison ring configured for use in a variable-vane assembly of a turbocharger is also described. The unison ring comprises a ring-shaped member having a radially outer surface and a radially inner surface, the radially inner surface defining a plurality of circumferentially spaced engaging elements configured to each engage an arm of the variable vane assembly. Each engaging element comprises an inner surface, wherein each inner surface is configured as a conjugate curve profile with respect to another profile. The conjugate curve profile may comprise an involute curve profile, such as an involute of a circle. Further, at least one of the engaging elements may be a main-arm-engaging element configured to actuate movement of the unison ring. Alternatively or additionally, at least one of the engaging elements may be an arm-engagement element configured to actuate movement of the arm.

### BRIEF DESCRIPTION OF THE SEVERAL VIEWS OF THE DRAWING(S)

Having thus described the embodiments in general terms, reference will now be made to the accompanying drawings, which are not necessarily drawn to scale, and wherein:

FIG. 1 illustrates a sectional view of an embodiment of a variable-geometry turbocharger assembly;

FIG. 2 illustrates a perspective view of a variable-vane assembly from the variable-geometry turbocharger assembly of FIG. 1;

FIG. 3 illustrates an involute curve;

FIG. 4 illustrates an enlarged partial top view of a main-arm and a unison ring from the variable-vane assembly of FIG. 2 in a first position;

FIG. 5 illustrates the main-arm and unison ring from FIG. 4 in a second position;

FIG. 6 illustrates an enlarged partial top view of a vane arm and the unison ring from the variable-vane assembly of FIG. 2 in a first position; and

FIG. 7 illustrates the vane arm and unison ring from FIG. 6 in a second position.

### DETAILED DESCRIPTION OF THE DRAWINGS

Variable-geometry turbocharger assemblies comprising unison rings and vane arms and/or main arms having conjugate curve profiles now will be described more fully hereinafter with reference to the accompanying drawings in which some but not all embodiments are shown. Indeed, the present development may be embodied in many different forms and should not be construed as limited to the embodiments set forth herein; rather, these embodiments are provided so that this disclosure will satisfy applicable legal requirements. Like numbers refer to like elements throughout.

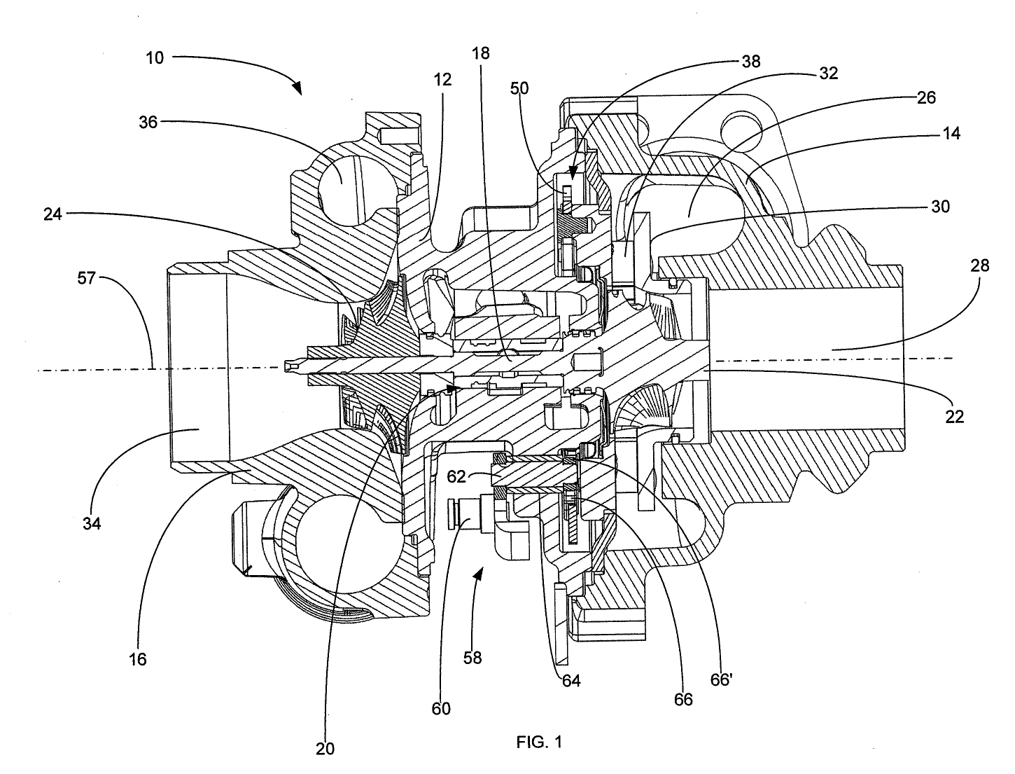

Referring to FIG. 1, an embodiment of a variable-nozzle turbocharger 10 generally comprises a center housing 12 having a turbine housing 14 attached at one end, and a compressor housing 16 attached at an opposite end. A shaft 18 is rotatably disposed within a bearing assembly 20 contained within the center housing 12. A turbine or turbine wheel 22 is attached to one end of the shaft 18 and is disposed within the turbine housing 14, and a compressor impeller 24 is attached to an opposite end of the shaft and is disposed within the compressor housing 16.

The turbine housing 14 defines an exhaust gas chamber or volute 26 that is configured to receive exhaust gas for supply to the turbine wheel 22, and an exhaust gas outlet 28 that is configured to direct exhaust gas axially away from the turbine wheel and the turbine housing. Exhaust gas, or other high-energy gas supplying the turbocharger 10, enters the volute 26 through an inlet (not shown) and is distributed around the volute for substantially radially inward delivery to the turbine wheel 22 through a nozzle 30 defining a nozzle passage 32. The compressor housing 16 includes an air inlet 34, for directing air axially to the compressor impeller 24, and a volute 36 for receiving pressurized air from the compressor impeller for supply to an engine intake system. As will be described below, a variable-vane assembly 38 is generally positioned between the center housing 12 and turbine housing 14.

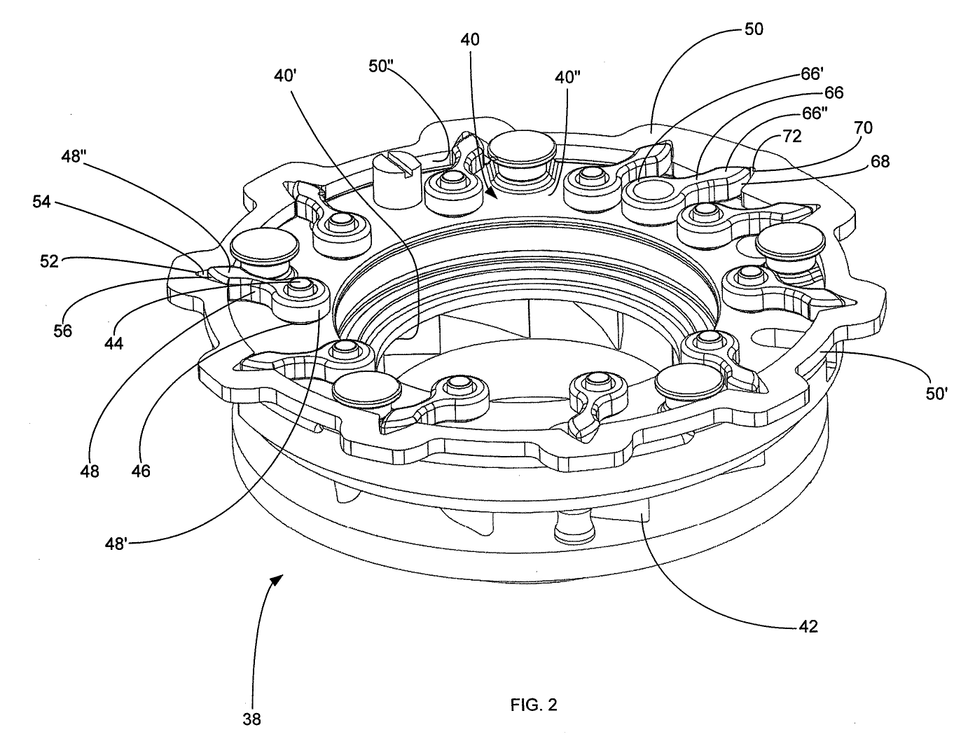

As illustrated in one embodiment of a variable-vane assembly 38 in FIG. 2, the variable-vane assembly includes a nozzle ring 40 that rotatably supports a plurality of vanes 42 adjacent a first face 40′ of the nozzle ring. Each vane 42 is fixedly mounted on a bearing pin 44 that extends through a bearing aperture 46 in the nozzle ring 40. A corresponding plurality of vane arms 48 are respectively connected to each of the vanes 42. Specifically, each vane arm 48 comprises a proximal end 48′ fixedly attached to the end of the respective bearing pin 44 that projects beyond an opposite second face 40″ of the nozzle ring 40. Thus the vanes 42 can be pivoted about their axes defined by the respective bearing pins 44 by pivoting the corresponding vane arms 48 so as to change the setting angles of the vanes 42. In order to pivot the vanes 42 in unison, an actuator ring or unison ring 50 is disposed adjacent the second face 40″ of the nozzle ring 40. The unison ring 50 comprises a generally ring-shaped member having a radially outer surface 50′ and a radially inner surface 50″. The inner surface 50″ defines a plurality of circumferentially spaced vane arm-engaging elements 52. Each vane arm-engaging element 52 comprises an inner contact surface 54 that engages an outer contact surface 56 defined by a distal end 48″ of a respective one of the vane arms 48. Accordingly, rotation of the unison ring 50 substantially about a longitudinal axis 57 defined by the shaft 18 (see FIG. 1) pivots the vanes 42 about the respective axes defined by the bearing pins 44 to change the vane setting angle, as described above.

Returning to FIG. 1, an actuation mechanism 58 is used to rotate the unison ring 50. The actuation mechanism 58 may comprise an external arm 60 that connects to an actuator crank 62. The actuator crank 62 extends through a hole 64 in the center housing 12 and connects to a first end 66′ of a main-arm 66. As illustrated in FIG. 2, a second end 66″ of the main arm 66 defines an outer actuation surface 68 configured for engaging a main-arm-engaging element 70 defined in the radially inner surface 50″ of the unison ring 50. Thus, as the external arm 60 (see FIG. 1) is actuated, the outer actuation surface 68 of the main-arm 66 engages an inner actuation surface 72 of the main-arm-engaging element 70 to thereby cause rotation of the unison ring 50, which changes the setting angle of the vanes 42 as described above.

However, the inventors of the present application have discovered that the actual rate of movement of the vanes 42 may lag behind the requested rate of movement of the vanes because of hysteresis effects. The inventors further discovered that contributing factors to the hysteresis include friction resulting from sliding contact between the vane arms 48 and the vane arm-engaging elements 52 and sliding contact between the main-arm 66 and the main-arm-engaging element 70. The frictional force associated with this contact is a function of the normal force and the slip velocity.

Accordingly, the turbocharger 10 comprises features intended to reduce the slip velocity and thereby reduce friction. In particular, portions of the variable-vane assembly 38 may comprise conjugate curve profiles. Conjugate curve profiles are shapes of bodies which allow uniform rotary motion to be transmitted from a first rotating body to a second rotating body when they engage one-another at surfaces that define conjugate curve profiles. This means that when the first rotating body moves at a constant angular velocity, the second rotating body will also move at a constant angular velocity.

Further, when the two surfaces that engage each other are conjugate curve profiles, all points of contact between the two members occur along a line. Accordingly, the force direction between the members remains constant. Additionally, use of conjugate curve profiles theoretically reduces slip velocity between the two engaging surfaces. In other words, the engaging surfaces effectively roll against each other, as opposed to sliding against each other. Thereby, sliding friction is theoretically drastically reduced (though in practice some sliding friction will remain).

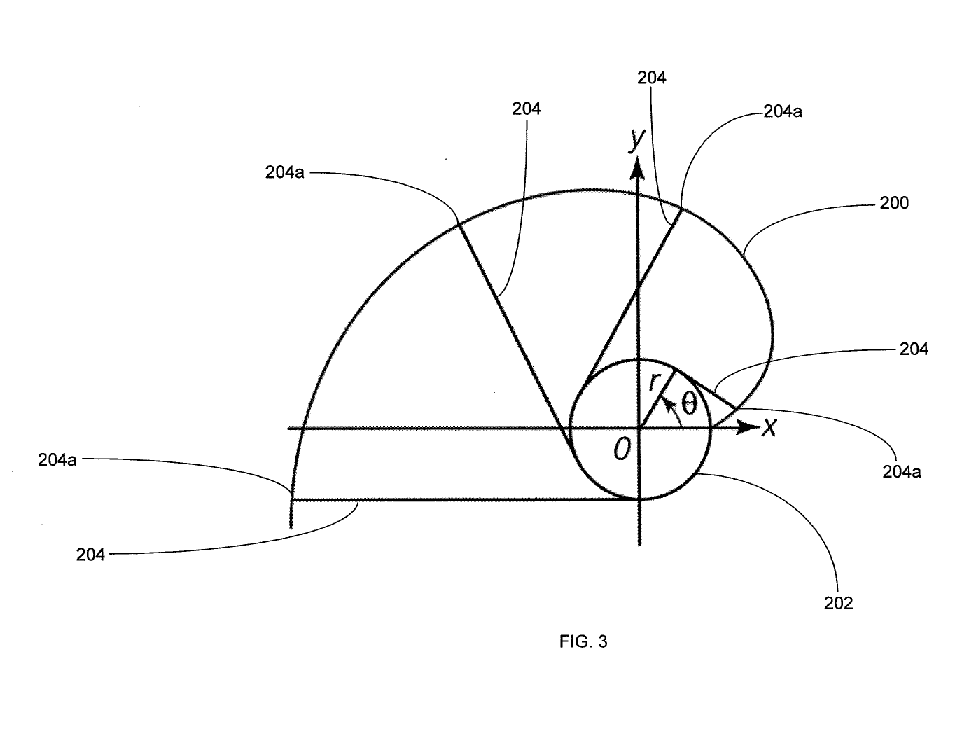

Although many conjugate curve profiles are possible, one type that is sometimes used to define the shape of gear teeth is an involute curve profile. An involute curve may be created by attaching an imaginary taut string to an original curve and tracing the imaginary string's free end as it is wound onto or unwound from that curve. For example, FIG. 3 illustrates the creation of an embodiment of an involute curve 200. The involute curve 200 is created based on an original curve that is a circle 202. The involute curve 200 may be traced out by following the end 204a of an imaginary string 204 as it is unwound from (or wound onto) the circle 202. The parametric equation for the involute curve 200 is given by the following:

xᵢ=r(cos(θ)+θ sin(θ)), and (1)

yᵢ=r(sin(θ)−θ cos(θ)), (2)

wherein r represents the radius of the circle 202, and θ represents the angle between the tangent to the circle at the string 204 and the axis x. Using this equation, the initial position of the end 204a of the imaginary string is (r, 0). In order to define a two-sided member with two involute curve profiles, two opposite-hand involute curves are combined such that they meet at a point. However, the point where the involute curves meet may be removed in some embodiments such that the member forms a blunted end, or the point where they meet may be rounded. Such embodiments may be easier to manufacture than sharp tips defined by intersecting involute curves.

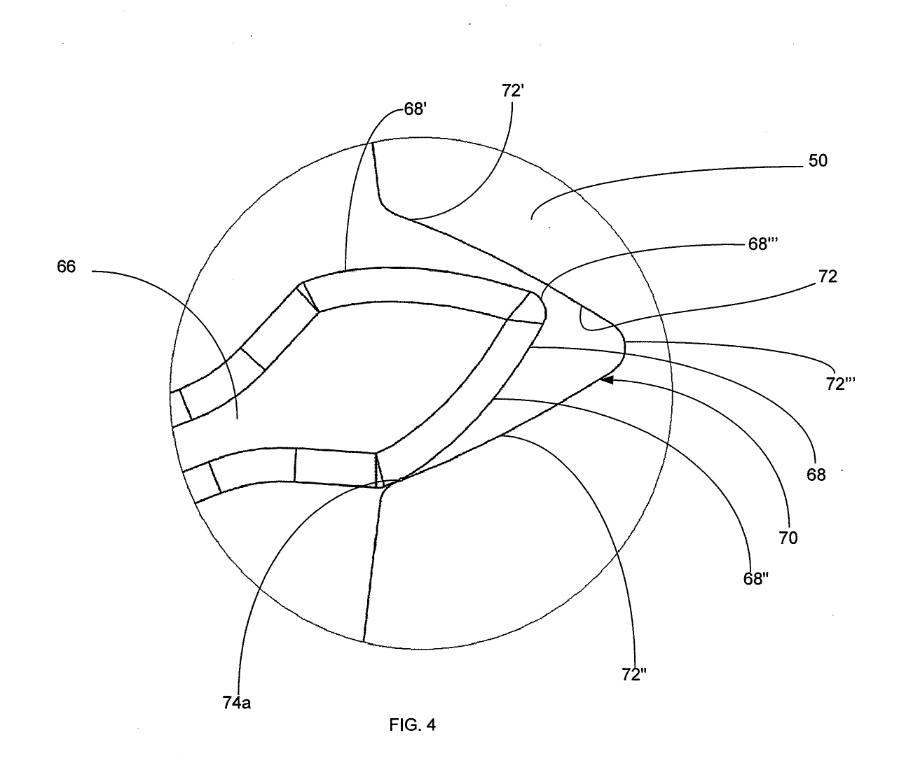

As described above, the inventors identified sliding movement between the unison ring 50 and vane arms 48 and/or main-arm 66 as potential sources of friction contributing to hysteresis during pivoting of the vanes in a variable-nozzle turbocharger 10 (see FIGS. 1 and 2). One idea conceived by the inventors was to apply conjugate curve profiles to the unison ring 50 and the vane arms 48 and/or the main-arm 66. Application of this idea is illustrated in FIG. 4, which shows an enlarged partial top view of the variable-nozzle assembly 38 from FIGS. 2.

Specifically, FIG. 4 shows the main arm 66 in combination with the unison ring 50 in a first position, which corresponds to a relatively closed position for the vanes 42. As illustrated, both the inner actuation surface 72 of the main-arm-engaging element 70 and the outer actuation surface 68 of the main-arm 66 comprise conjugate curve profiles. In particular, the inner actuation surface 72 and the outer actuation surface 68 define involute curve profiles comprising involutes of original curves that are circles (see, e.g. involute 200 and circle 202 in FIG. 3).

Although the original curves may be circles that have the same radius, this is not necessarily the case. The involute curve profile of the inner actuation surface 72 may comprise an involute of a first circle, and the involute curve profile of the outer actuation surface 72 may comprise an involute of a second circle. In such configurations, the radius of the first circle can be less than, equal to, or greater than the radius of the second circle. For example, in the illustrated embodiment, the inner actuation surface 72 comprises first and second involute portions 72′, 72″ that are slightly shorter than the first and second involute portions 68′, 68″ of the outer actuation surface 68, which is a result of the involute curve profile of the main-arm 66 being based off of a slightly larger base circle. With further regard to the main-arm 66 and the unison ring 50, the end 72′″ of the inner actuation surface 72 and the end 68″′ of the outer actuation surface 68 may be rounded as illustrated. As described above, this can simplify manufacturing of the main-arm 66 and the unison ring 50, by not requiring the production of sharp curve transitions where the involute curves would otherwise meet.

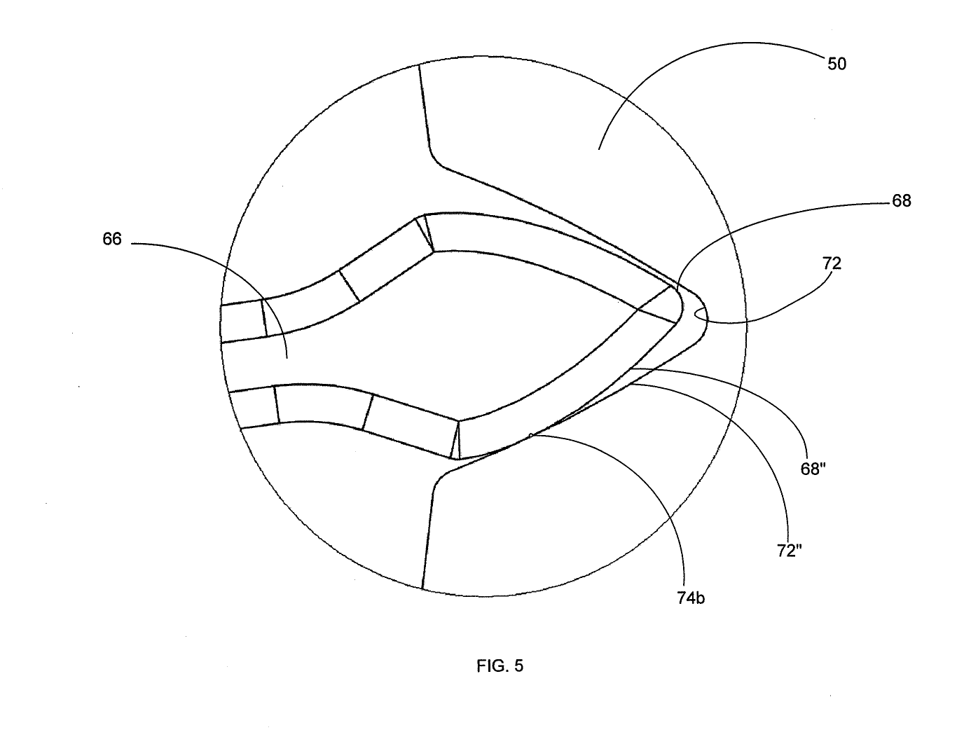

As a result of the inner actuation surface 72 and the outer actuation surface 68 defining conjugate curve profiles, friction from sliding between the main-arm 66 and unison ring 50 may be reduced as the main-arm is actuated in order to open or close the vanes 42 (see FIG. 2). For example, the point of contact between the main-arm 66 and the unison ring 50 shifts from point 74a to point 74b (shown in FIG. 5) as the main-arm rotates the unison ring in order to open the vanes 42. Due to the points 74a and 74b lying along portions 72″, 68″, where the inner actuation surface 72 and the outer actuation surface 68 are defined by involute curves, the movement between the main-arm 66 and the unison ring 50 is substantially a rolling motion. Thus sliding friction between the main-arm 66 and the unison ring 50 may be reduced.

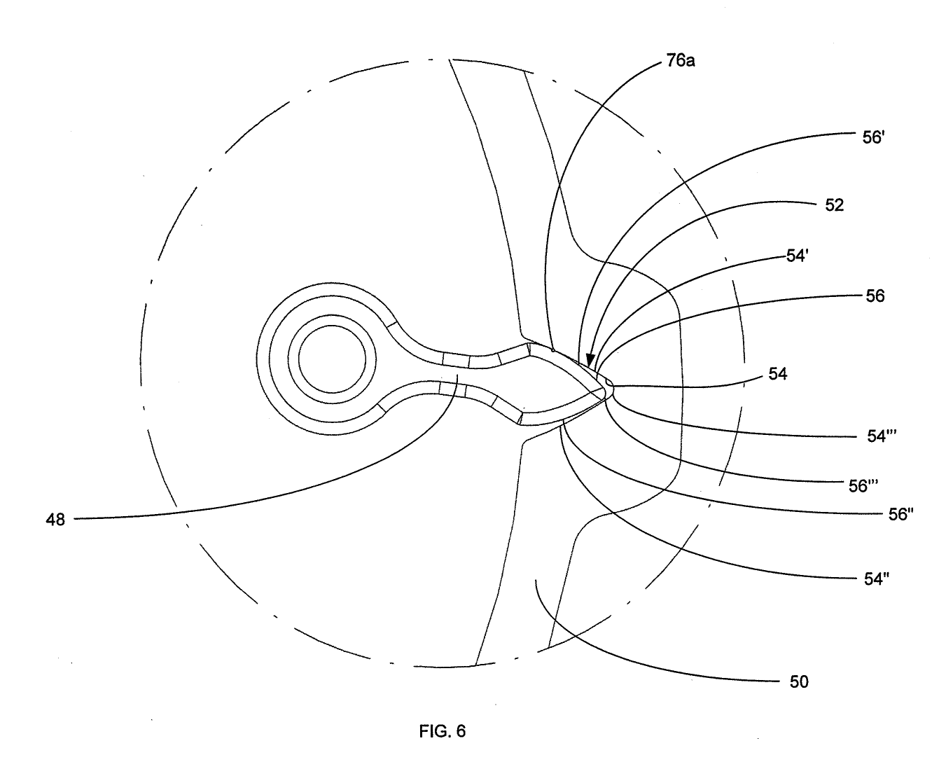

Additionally or alternatively, the vane arms 48 may each comprise a conjugate curve profile. For example, FIG. 6 shows a vane arm 48 in combination with the unison ring 50 in a first position, which corresponds to a relatively closed position for the vanes 42. As illustrated, both the inner contact surface 54 of the vane arm-engaging element 52 and the outer contact surface 56 of the vane arm 48 comprise conjugate curve profiles. In particular, the inner contact surface 54 and the outer contact surface 56 define involute curve profiles comprising involutes of original curves that are circles (see, e.g. involute 200 and circle 202 in FIG. 3).

Although the original curves may be circles that have the same radius, this is not necessarily the case. The involute curve profile of the inner contact surface 54 may comprise an involute of a first circle, and the involute curve profile of the outer contact surface 56 may comprise an involute of a second circle. In such configurations, the radius of the first circle can be less than, equal to, or greater than the radius of the second circle. For example, in the illustrated embodiment, the inner contact surface 54 comprises first and second involute portions 54′, 54″ that are slightly shorter than the first and second involute portions 56′, 56″ of the outer contact surface 56, which is a result of the involute curve profile of the vane arm 48 being based off of a slightly larger base circle. With further regard to the vane arm 48 and the unison ring 50, the end 54′″ of the inner contact surface 54 and the end 56″′ of the outer contact surface 56 may be rounded as illustrated. As described above, this can simplify manufacturing of the vane arm 48 and the unison ring 50, by not requiring the production of sharp curve transitions where the involute curves would otherwise meet.

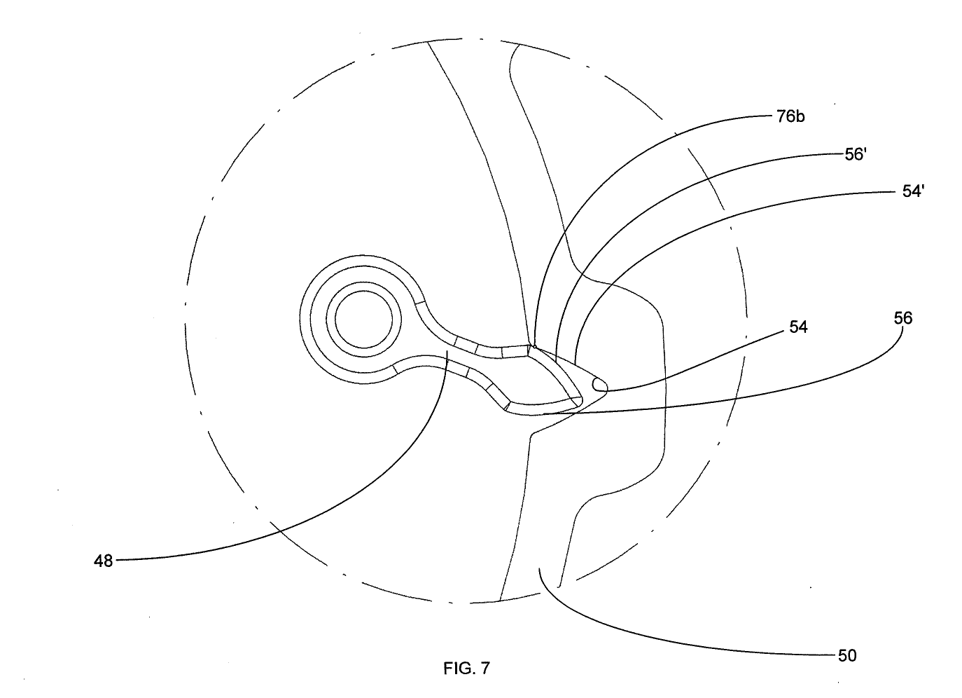

As a result of the inner contact surface 54 and the outer contact surface 56 defining conjugate curve profiles, friction from sliding between the vane arms 48 and unison ring 50 may be reduced as the vane arms are pivoted by the unison ring in order to open or close the vanes 42 (see FIG. 2). For example, the points of contact between the vane arms 48 and the unison ring 50 shift from point 76a to point 76b shown in FIG. 7 as the unison ring rotates the vane arms in order to open the vanes 42. Due to the points 76a and 76b lying along portions 54′, 56′, where the inner contact surface 54 and the outer contact surface 56 are defined by involute curves, the movement between the vane arms 48 and the unison ring 50 is substantially a rolling motion. Thus sliding friction between the vane arms 48 and the unison ring 50 may be reduced.

Although embodiments are generally described above as using involute curves, other types of conjugate curve profiles may instead be used. For example, cycloidal curves may be used. Additionally, although the inner contact surface, outer contact surface, inner actuation surface, and outer actuation surface are illustrated as comprising conjugate curve profiles on both sides, in some embodiments only one side of these elements may comprise conjugate curve profiles. Further, although use of vane arms, a unison ring, and a main-arm having conjugate curve profiles was described above with respect to a particular embodiment of a turbocharger, many different embodiments of turbochargers may employ these features.

Many modifications and other embodiments will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Although specific terms are employed herein, they are used in a generic and descriptive sense only and not for purposes of limitation.

That which is claimed:

1. A variable-geometry turbocharger assembly, comprising:
a turbine housing defining an inlet for exhaust gas and an outlet;
a turbine wheel within the turbine housing and attached to a shaft;
a nozzle at least partially defining a nozzle passage for exhaust gas flow to the turbine wheel;
a plurality of vanes disposed within the nozzle passage, each vane mounted on a bearing pin and each vane configured to pivot about an axis defined by the respective bearing pin;
a plurality of vane arms each comprising a proximal end connected to a respective one of the vanes and an opposite distal end defining an outer contact surface; and
a unison ring rotatable substantially about a longitudinal axis defined by the shaft for pivoting the vanes about the respective axes, the unison ring comprising a radially inner surface defining a plurality of circumferentially spaced vane arm-engaging elements each engaged with the distal end of one of the vane arms, each vane arm-engaging element comprising an inner contact surface that engages the outer contact surface of the respective vane arms,
wherein the inner contact surface of each arm-engaging element and the outer contact surface of each vane arm are configured as conjugate curve profiles.

2. The turbocharger assembly of claim 1, wherein the conjugate curve profiles comprise involute curve profiles.

3. The turbocharger assembly of claim 2, wherein each of the involute curve profiles comprises an involute of a circle.

4. The turbocharger assembly of claim 3, wherein the involute curve profile of the inner contact surface of each arm-engaging element comprises the involute of a first circle,
wherein the involute curve profile of the outer contact surface of each vane arm comprises the involute of a second circle, and
further wherein the radius of the first circle is greater than the radius of the second circle.

5. The turbocharger assembly of claim 3, wherein the involute curve profile of the inner contact surface of each arm-engaging element comprises the involute of a first circle,
wherein the involute curve profile of the outer contact surface of each vane arm comprises the involute of a second circle, and
further wherein the radius of the first circle is less than the radius of the second circle.

6. The turbocharger assembly of claim 1, further comprising one or more main-arms each comprising an outer actuation surface, the radially inner surface of the unison ring further defining one more main-arm-engaging elements each engaged with one of the main-arms, each main-arm-engaging element comprising an inner actuation surface that engages the outer actuation surface of the respective main-arms.

7. The turbocharger assembly of claim 6, wherein the inner actuation surface of each main-arm-engaging element and the outer actuation surface of each main-arm are configured as conjugate curve profiles.

8. The turbocharger assembly of claim 7, wherein the conjugate curve profiles of the inner actuation surface and the outer actuation surface and/or the inner contact surface and the outer contact surface comprise involute curve profiles

9. A variable-geometry turbocharger assembly, comprising:
a turbine housing defining an inlet for exhaust gas and an outlet;
a turbine wheel within the turbine housing and attached to a shaft;
a nozzle at least partially defining a nozzle passage for exhaust gas flow to the turbine wheel;
a plurality of vanes disposed within the nozzle passage, each vane mounted on a bearing pin and each vane configured to pivot about an axis defined by the respective bearing pin;
a plurality of vane arms each comprising a proximal end connected to a respective one of the vanes and an opposite distal end defining an outer contact surface;
one or more main-arms each comprising an outer actuation surface; and
a unison ring rotatable substantially about a longitudinal axis defined by the shaft for pivoting the vanes about the respective axes, the unison ring comprising a radially inner surface defining:
a plurality of circumferentially spaced vane arm-engaging elements each engaged with the distal end of one of the vane arms, each arm-engaging element comprising an inner contact surface that engages the outer contact surface of the respective vane arms, and
one or more main-arm-engaging elements each engaged with one of the main-arms, each main-arm-engaging element comprising an inner actuation surface that engages the outer actuation surface of the respective main-arms,
wherein the inner actuation surface of each main-arm-engaging element and the outer actuation surface of each main-arm are configured as conjugate curve profiles.

10. The turbocharger assembly of claim 9, wherein the conjugate curve profiles comprise involute curve profiles.

11. The turbocharger assembly of claim 10, wherein each of the involute curve profiles comprises an involute of a circle.

12. The turbocharger assembly of claim 11, wherein the involute curve profile of the inner actuation surface of each main-arm-engaging element comprises the involute of a first circle,
wherein the involute curve profile of the outer actuation surface of each main-arm comprises the involute of a second circle, and
further wherein the radius of the first circle is greater than the radius of the second circle.

13. The turbocharger assembly of claim 11, wherein the involute curve profile of the inner actuation surface of each main-arm-engaging element comprises the involute of a first circle,
wherein the involute curve profile of the outer actuation surface of each main-arm comprises the involute of a second circle, and
further wherein the radius of the first circle is less than the radius of the second circle.

14. A vane arm for use in a variable-vane assembly of a turbocharger, comprising:
a first end configured for connection with a vane; and
a second end defining an outer contact surface for engaging a unison ring of the variable-vane assembly,
wherein the outer contact surface defines a conjugate curve profile.

15. The vane arm of claim 14, wherein the conjugate curve profile comprises an involute curve profile.

16. The vane arm of claim 15, wherein the involute curve profile comprises an involute of a circle.

17. A main-arm for use in a variable-vane assembly of a turbocharger, comprising:
a first end configured for connection with an actuation mechanism of the variable-geometry nozzle; and
a second end defining an outer actuation surface for engaging a unison ring of the variable-vane assembly,
wherein the outer actuation surface defines a conjugate curve profile.

18. The vane arm of claim 17, wherein the conjugate curve profile comprises an involute curve profile.

19. The vane arm of claim 18, wherein the involute curve profile comprises an involute of a circle.

20. A unison ring configured for use in a variable-vane assembly of a turbocharger, comprising:
a ring-shaped member having a radially outer surface and a radially inner surface, the radially inner surface defining a plurality of circumferentially spaced engaging elements configured to each engage an arm of the variable vane assembly, each engaging element comprising an inner surface,
wherein each inner surface is configured as a conjugate curve profile.

21. The unison ring of claim 20, wherein at least one of the engaging elements is a main-arm-engaging element configured to actuate movement of the unison ring.

22. The unison ring of claim 20, wherein at least one of the engaging elements is an arm-engagement element configured to actuate movement of the arm.

23. The unison ring of claim 20, wherein the conjugate curve profile comprises an involute curve profile.

24. The unison ring of claim 23, wherein the involute curve profile comprises an involute of a circle.
